(19) United States
(12) Patent Application Publication
(10) Pub. No.: US 2005/0050115 A1
(43) Pub. Date: Mar. 3, 2005

(54) Method and system of providing cascaded replication

(76) Inventor: Anand A. Kekre, Pune (IN)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 10/652,326

(22) Filed: Aug. 29, 2003

(51) Int. Cl. G06F 17/30

(52) U.S. Cl. 707/204

(57) ABSTRACT

A method and system of providing cascaded replication is disclosed. According to one embodiment a method is provided in which data to be written to a data volume of a first node is replicated to a data volume of a second node and data to be written to the data volume of the second node is replicated to a data volume of a third node where at least one of the replication operations includes asynchronous data replication.

### BACKGROUND

1. Technical Field

The present invention relates to data storage and retrieval generally and more particularly to a method and system of providing cascaded replication.

2. Description of the Related Art

Information drives business. Companies today rely to an unprecedented extent on online, frequently accessed, constantly changing data to run their businesses. Unplanned events that inhibit the availability of this data can seriously damage business operations. Additionally, any permanent data loss, from natural disaster or any other source, will likely have serious negative consequences for the continued viability of a business. Therefore, when disaster strikes, companies must be prepared to eliminate or minimize data loss, and recover quickly with useable data.

Replication is one technique utilized to minimize data loss and improve the availability of data in which a replicated copy of data is distributed and stored at one or more remote sites or nodes. In the event of a site migration, failure of one or more physical disks storing data or of a node or host data processing system associated with such a disk, the remote replicated data copy may be utilized, ensuring data integrity and availability. Replication is frequently coupled with other high-availability techniques such as clustering to provide an extremely robust data storage solution. Metrics typically used to assess or design a particular replication system include recovery point or recovery point objective (RPO) and recovery time or recovery time objective (RTO) performance metrics as well as a total cost of ownership (TCO) metric.

The RPO metric is used to indicate the point (e.g., in time) to which data (e.g., application data, system state, and the like) must be recovered by a replication system. In other words, RPO may be used to indicate how much data loss can be tolerated by applications associated with the replication system. The RTO metric is used to indicate the time within which systems, applications, and/or functions associated with the replication system must be recovered. Optimally, a replication system would provide for instantaneous and complete recovery of data from one or more remote sites at a great distance from the data-generating primary node. The high costs associated with the high-speed link(s) required by such optimal replication systems have discouraged their implementation however in all but a small number of application environments.

Replication systems in which alternatively high-frequency data replication is performed over short, high-speed links or low-frequency data replication is performed over longer, low-speed links alone similarly suffer from a number of drawbacks (e.g., a poor RPO metric, high write operation/application latency, high cost, replication and/or recovery failure where an event negatively impacts a primary node and one or more nodes including replicated data due to geographic proximity). Consequently a number of replication systems have been implemented in which such short-distance, high-speed/frequency replication (e.g., real-time or synchronous replication) is coupled (e.g., cascaded) with long-distance, low-speed/frequency replication.

FIG. 1 illustrates a cascaded replication system according to the prior art. In the illustrated cascaded replication system, synchronous replication is performed between a primary node 100 and an intermediary node 102 while periodic replication is performed between intermediary node 102 and a secondary node 104. While a single intermediary node 102 has been illustrated in the system of FIG. 1 it should be understood that additional intermediary nodes may be provided serially or in parallel between primary node 100 and secondary node 104. Primary node 100 of the illustrated system includes an application 106 (e.g, a database application) coupled to a data volume 108 or other storage area via a replication facility 110.

Primary node 100 additionally includes a storage replicator log (SRL) 112 used to effect replication (e.g., synchronous replication). In a typical cascaded replication system such as that illustrated in FIG. 1, SRL 112 is used to store or “journal” data to be written by one or more write operations requested by an application such as application 106 during primary node 100's operation.

It is assumed for purposes of this description that the data volumes of primary node 100, intermediary node 102, and secondary node 104 are initially synchronized. Intermediary node 102 of the illustrated prior art replication system includes a replication facility 114, a data volume 116, and a snapshot data volume 118 as shown. In synchronous replication, when application 106 requests that a write operation be performed on its behalf to data volume 108, replication facility 110 intercepts the write. Replication facility 110 then writes the data to be written by the requested write operation to storage replicator log (SRL) 112. It is not required that such data is written to a storage replicator log, although a storage replicator log is valuable in assisting with recovery upon node failure. The data may be written directly to data volume 108 or into a memory buffer that is later copied to data volume 108.

Replication facility 110 then replicates the data to be written to data volume 116 within intermediary node 102. In one prior art replication system, such replication is performed by copying the data to be written, and transferring the generated copy to data volume 116. Replication facility 110 then asynchronously issues a write operation to write the data to be written locally to data volume 108. In a conventional replication system implementing synchronous replication, writing the data to the SRL 112, writing data to local data volume 108 and transferring a copy of the data to be written to intermediary node may start and/or complete in any order or may be performed in parallel.

The data is then written to data volume 108. Because the updated data resulting from the write operation is sent to a node that is updated synchronously, replication facility 110 waits until an acknowledgement is received from replication facility 114 before notifying application 106 that the write operation is complete. The described data transfer between primary node 100 and intermediary node 102 is performed over a communication link (e.g., a communications network and storage area network (SAN)) between the nodes. Upon receiving replicated data, replication facility 114 on intermediary node 102 issues a write command to write the data directly to data volume 116.

An acknowledgement is then transmitted from intermediary node 102 to primary node 100 indicating that the write operation or “update” has been received. Upon receiving the described acknowledgement, replication facility 110 on node 100 notifies application 106 that the write operation is complete. Primary node 100, intermediary node 102, and secondary node 104 may include more or fewer components in alternative prior art embodiments. For example, primary node 100 may include additional data volumes beyond data volume 108 and/or a data volume or storage area manager used to coordinate the storage of data within any associated data volume.

In the periodic replication of the illustrated replication system, data volume 124 within secondary node 104 is periodically updated with changes resulting from write operations on data volume 116 over a period of time. At the beginning of an initial time period a snapshot data volume 118 is created corresponding to data volume 116.

FIG. 2 illustrates a one-to-many replication system used in place of a cascaded replication system according to the prior art. In the illustrated replication system, data is synchronously replicated between a data volume 208 within a primary node 200 and a data volume 216 within a first secondary node 202 as data is periodically replicated between the data volume 208 within the primary node 200 and a data volume 224 within a second secondary node 204 as described in more detail herein. A significant shortcoming of the illustrated one-to-many replication system is that substantial resources of primary node 200 and its associated replication facility 210 are required to perform the multiple illustrated replication operations.

### SUMMARY OF THE INVENTION

Disclosed is a method and system of providing cascaded replication. According one embodiment of the present invention, data is asynchronously replicated between data volumes of two or more nodes within a cascaded replication system. Data may be asynchronously replicated between a primary data volume and an intermediary data volume or alternatively between an intermediary data volume and one or more secondary data volumes.

Embodiments of the present invention may be used to quickly and reliably replicate data to one or more secondary nodes while reducing replication costs and write operation latency. By providing asynchronous replication within a cascaded replication system, data may be replicated initially over a relatively shorter and higher cost/bandwidth link and subsequently over a comparatively longer and lower cost/bandwidth link while write operation latency for applications and primary node loading are reduced as compared with conventional synchronous replication-based cascaded replication systems.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous features and advantages made apparent to those skilled in the art by referencing the accompanying drawings in which:

FIG. 1 illustrates a cascaded replication system according to the prior art;

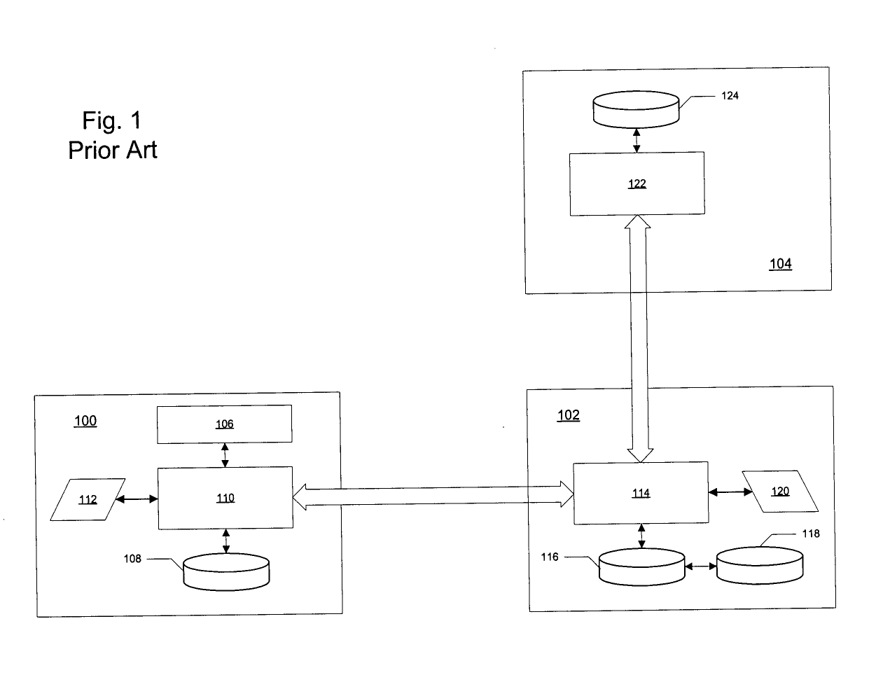

FIG. 2 illustrates a one-to-many replication system used in place of a cascaded replication system according to the prior art;

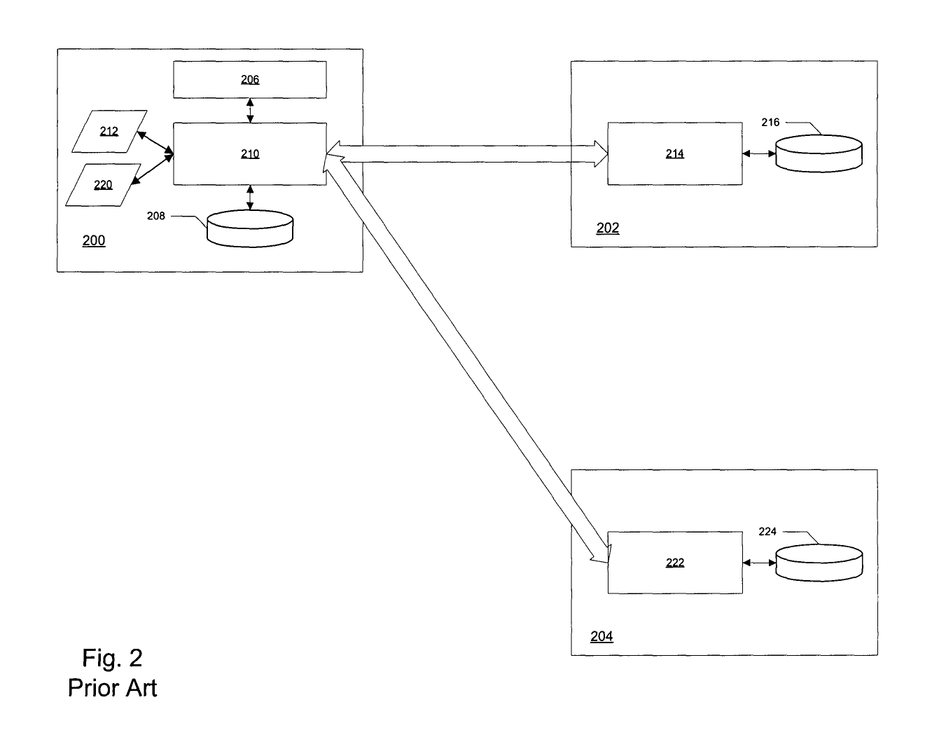

FIG. 3 illustrates a cascaded replication system according to a first embodiment of the present invention;

FIG. 4 illustrates a cascaded replication system according to a second embodiment of the present invention;

FIG. 5 illustrates a cascaded replication system including a replication multiplexer according to an embodiment of the present invention;

FIG. 6 illustrates a cascaded replication process according to an embodiment of the present invention; and

FIG. 7 illustrates an exemplary data processing system useable with one or more embodiments of the present invention.

The use of the same reference symbols in different drawings indicates similar or identical items.

### DETAILED DESCRIPTION

Although the present invention has been described in connection with one embodiment, the invention is not intended to be limited to the specific forms set forth herein. On the contrary, it is intended to cover such alternatives, modifications, and equivalents as can be reasonably included within the scope of the invention as defined by the appended claims.

In the following detailed description, numerous specific details such as specific method orders, structures, elements, and connections have been set forth. It is to be understood however that these and other specific details need not be utilized to practice embodiments of the present invention. In other circumstances, well-known structures, elements, or connections have been omitted, or have not been described in particular detail in order to avoid unnecessarily obscuring this description.

References within the specification to “one embodiment” or “an embodiment” are intended to indicate that a particular feature, structure, or characteristic described in connection with the embodiment is included in at least one embodiment of the present invention. The appearance of the phrase “in one embodiment” in various places within the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

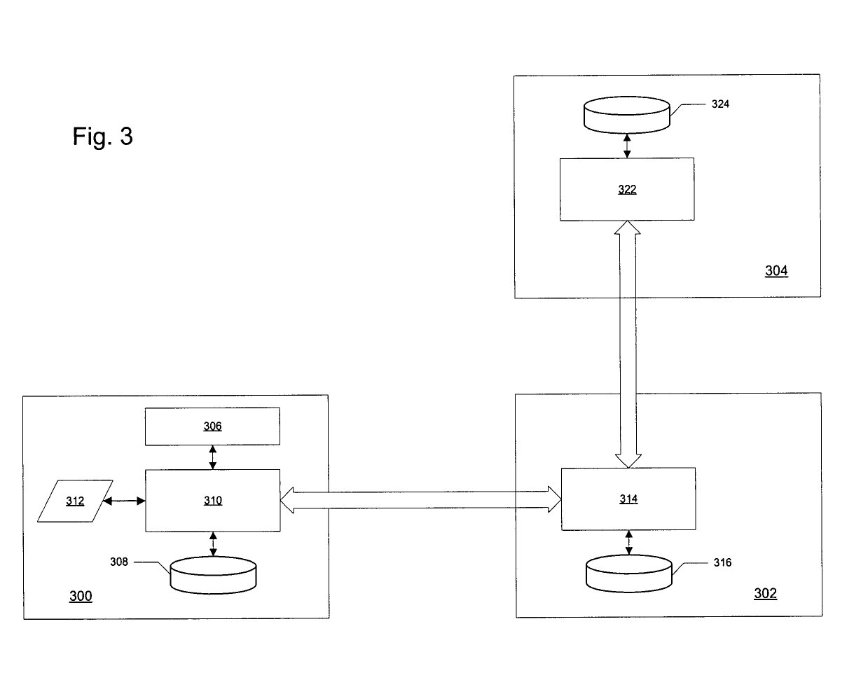

FIG. 3 illustrates a cascaded replication system according to a first embodiment of the present invention. In the illustrated cascaded replication system, asynchronous replication is performed between a primary node 300 and an intermediary node 302 thus reducing application write operation latency and cost while meeting desired recovery point objectives. Asynchronous replication utilizes a log area (e.g., a storage replicator log) to stage write operations such that the write operation can return as soon as data associated with the write operation (e.g., the data to be written, metadata, and the like) has been logged (i.e., stored) to this log area. Asynchronous replication requires write ordering (e.g., at a secondary node) to ensure that each replicated data volume is consistent. According to one embodiment of the present invention, writes are ordered by tagging each write with a globally increasing sequence number. In a distributed environment (e.g., SAN Volume Manager or Cluster Volume Manager provided by VERITAS Software Corporation of Mountain View, Calif.) this sequence number may be used to maintain the write order across various nodes (hosts, switches, appliances etc). According to still other embodiments of the present invention in such a distributed environment, the log or “journal” may alternately be shared or exclusive to each node of a group of nodes.

Replication between intermediary node 302 and secondary node 304 may then in turn be performed using one of several replication techniques (e.g., asynchronous and/or periodic replication) according to alternative embodiments of the present invention. In periodic replication a site or node (e.g., a secondary node) is periodically updated with changes that have been written (e.g., to an intermediary node) over a period of time. An exemplarly periodic replication technique, useable with embodiments of the present invention is described in U.S. Pat. No. 10/436,354, entitled, “Method and System of Providing Periodic Replication” incorporated herein by reference in its entirety and for all purposes.

While a single intermediary node 302 has been illustrated in the system of FIG. 3, it should be understood that additional intermediary nodes may be provided serially or in parallel between primary node 300 and secondary node 304. Primary node 300 of the illustrated system includes an application 306 (e.g., a database application) coupled to a data volume 308 or other storage area via a replication facility 310 such as the Volume Replicator product provided by VERITAS Software Corporation of Mountain View, Calif. According to one embodiment, cascaded data replication is performed on more than two levels (e.g., intermediary node and secondary node) as illustrated in FIG. 3. In the described embodiment, replication frequency (e.g., periodic replication frequency) may be reduced as the data is replicated from one node to another, for example, where available bandwidth decreases as the number of hops increases.

Primary node 300 additionally includes a storage replicator log (SRL) 312 used to effect the described asynchronous replication. In a typical cascaded replication system such as that illustrated in FIG. 3, SRL 312 is used to store or “journal” data to be written by one or more write operations requested by an application such as application 306 during primary node 300's operation. In another embodiment asynchronous replication may be effected by tracking data changes using a bitmap or an extent map rather than a log such as SRL 312. It is assumed for purposes of this description that the data volumes of primary node 300, intermediary node 302, and secondary node 304 are initially synchronized. Intermediary node 302 of the illustrated prior art replication system includes a replication facility 314, and a data volume 316 as shown.

In asynchronous replication, when application 306 requests that a write operation be performed on its behalf to data volume 308, replication facility 310 intercepts the write. Replication facility 310 then writes the data to be written by the requested write operation to storage replicator log (SRL) 312. It is not required that such data is written to a storage replicator log, although a storage replicator log is valuable in assisting with recovery upon node failure. For example, in one alternate embodiment such data can be tracked in bitmap or extent map to facilitate recovery. The data may be written directly to data volume 308 or into a memory buffer that is later copied to data volume 308. As soon as the data has been written to the SRL or tracked in a bit/extent map, replication facility 310 on node 300 may notify application 306 that the write operation is complete.

Thereafter, the data is written to data volume 308 and replicated to data volume 316 within intermediary node 302 by replication facility 310. In one embodiment, such replication is performed by copying the data to be written, and transferring the generated copy to data volume 316. As part of the described replication, confirmation of the intermediary node's receipt of the data to be written as well as the actual write operation of such data to data volume 316 may be transmitted to the primary node. Additionally, the data to be written may logged (e.g., using an SRL, not shown) within the intermediary node as part of such replication according to one embodiment of the present invention.

In the illustrated embodiment, the described data transfer between primary node 300 and intermediary node 302 is performed over a communication link (e.g., a communications network and SAN) between the nodes. In alternative embodiments, primary node 300, intermediary node 302, and secondary node 304 may include more or fewer components. For example, primary node 300 may include additional data volumes beyond data volume 308 and/or a data volume or storage area manager used to coordinate the storage of data within any associated data volume.

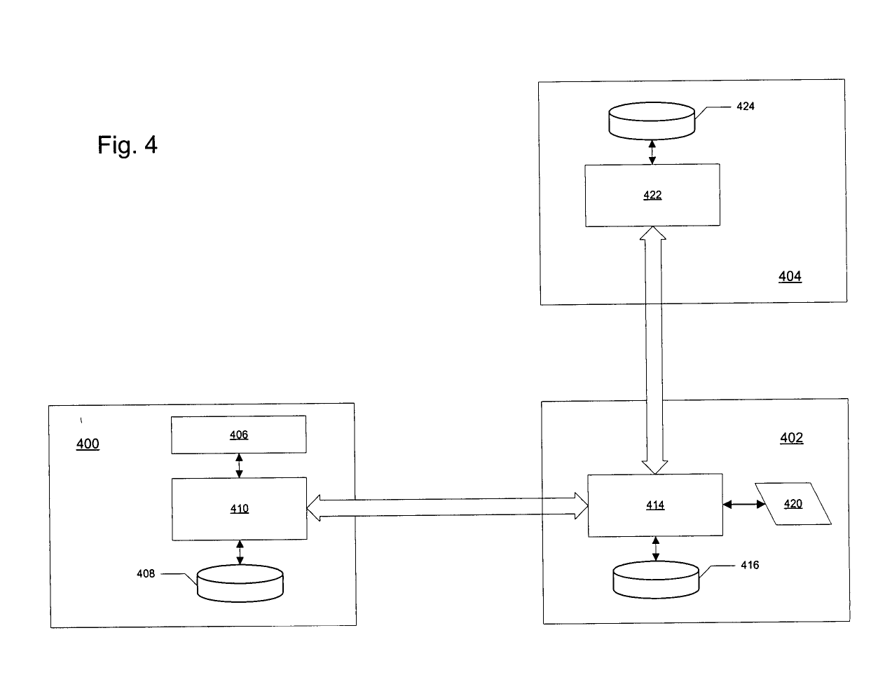

FIG. 4 illustrates a cascaded replication system according to a second embodiment of the present invention. In the illustrated cascaded replication system, asynchronous replication is performed between an intermediary node 402 and a secondary node 404 while replication between a primary node 400 and intermediary node 402 is performed using one of several replication techniques (e.g., synchronous, asynchronous, and/or periodic replication) according to alternative embodiments of the present invention. Asynchronous replication in the illustrated embodiment is performed as described with respect to FIG. 3 herein.

According to one or more embodiments of the present invention, replication repeaters and/or multiplexers may be provided. A replication node acting as a repeater or multiplexer according to one embodiment of the present invention includes limited or specialized data volume replication functionality. Exemplary repeaters and multiplexers include, but are not limited to, local multiplexers used to relieve a primary node from performing n-way replication (i.e., replication to “n” secondary nodes, where n is an integer) over a local area network (LAN); remote multiplexers used to perform such n-way replication across greater physical distance (e.g., using a Wide Area Network (WAN)); and repeaters. A repeater may be considered a specialized local or remote multiplexer having a single target node (i.e., where n is equal to one).

A replication repeater is provided according to one embodiment of the present invention utilizing two or more space-saving volumes (e.g., V1 and V2) such as are described for example in U.S. Pat. No. 10/436,354, entitled, “Method and System of Providing Periodic Replication” stored on a space saving construct (e.g., cache structured storage and/or log structured storage) that can be used to alternately store incremental transfers or updates. In the described embodiment, one of the space-saving volumes may be used to accept data from a first node (e.g., a primary node) while the other space-saving volume is used to transfer data received during a prior incremental transfer to a second node (e.g., a secondary node). Once this initial transfer is complete, the space-saving volumes' roles may be reversed with the described process being repeated to effectively double data replication throughput. In yet another embodiment, multiple sets of such space-saving volumes may be employed to perform replication multiplexing as described herein with similar effect.

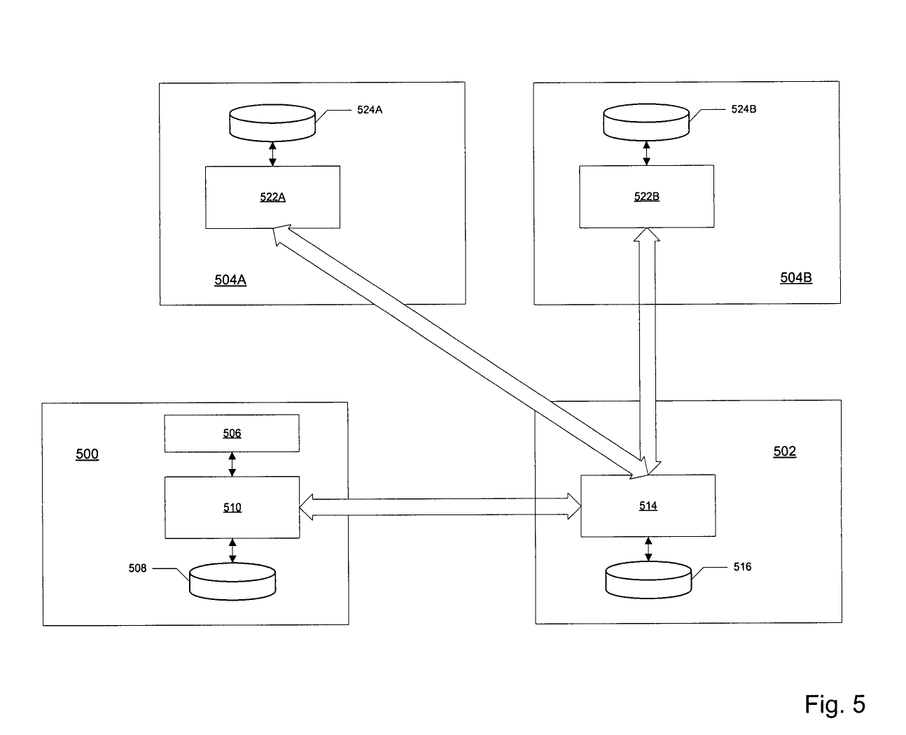

FIG. 5 illustrates a cascaded replication system including a replication multiplexer according to an embodiment of the present invention. In the illustrated embodiment, data is first replicated from a primary node 500 to an intermediary node 502 which in turn is used as a replication multiplexer to replicate data to multiple target secondary nodes 504A and 504B. While a single intermediary node 502 and two secondary nodes 504 have been illustrated in the system of FIG. 5, it should be understood that additional intermediary nodes and/or secondary nodes may be provided in alternative embodiments of the present invention.

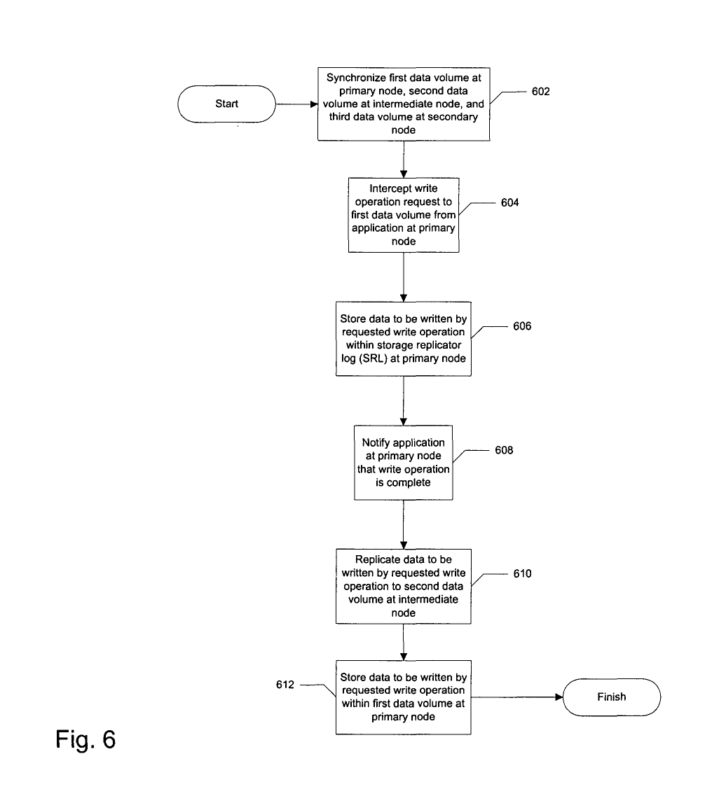

FIG. 6 illustrates a cascaded replication process according to an embodiment of the present invention. In the illustrated process embodiment a first data volume of a primary node, a second data volume of an intermediary node, and a third data volume of a secondary node are initially synchronized (process block 602). Such initially synchronization may be implemented according to various embodiments of the present invention using data transfer from one node data processing system to another across a network, tape or other persistent backup and restore capabilities, or one or more snapshots or portions thereof.

Following the initial synchronization of the described nodes and associated data volumes a request to perform a write operation on the first data volume is intercepted (e.g., using a replication facility) (process block 604). Thereafter, the data to be written by the intercepted write operation request is stored within a storage replicator log (SRL) at the primary node (process block 606) before the original requesting application is notified of the successful completion of the write (process block 608). In step 606 the data can alternately be marked in a bitmap or extent map before indicating successful completion of the write operation to the application. Thereafter the data to be written by the requested write operation is replicated to the second data volume at the intermediary node (process block 610).

According to one embodiment of the present invention, the described replication includes a cascaded replication operation from the second data volume to the third data volume of the secondary node (not illustrated). In alternative embodiments the described cascaded replication may be implemented as asynchronous replication and/or periodic replication. After the data to be written has been replicated as described, it is the stored within the first data volume at the primary node (process block 612). While operations of the illustrated process embodiment of FIG. 6 have been illustrated as being performed serially for clarity, it should be appreciated that one or more of such operations (e.g., the operations depicted by process blocks 608 through 612) may be performed in parallel in alternative embodiments of the present invention.

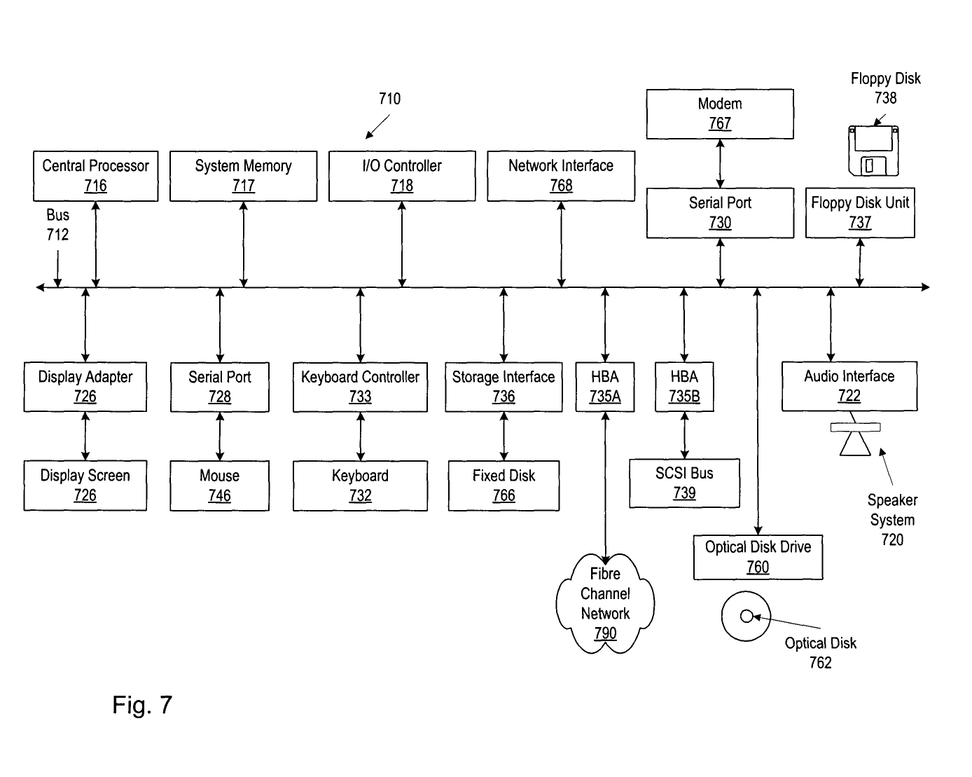

FIG. 7 illustrates an exemplary data processing system useable with one or more embodiments of the present invention. Data processing system 710 includes a bus 712 which interconnects major subsystems of data processing system 710, such as a central processor 714, a system memory 717 (typically RAM, but which may also include ROM, flash RAM, or the like), an input/output controller 718, an external audio device, such as a speaker system 720 via an audio output interface 722, an external device, such as a display screen 724 via display adapter 726, serial ports 728 and 730, a keyboard 732 (interfaced with a keyboard controller 733), a storage interface 734, a floppy disk drive 737 operative to receive a floppy disk 738, a host bus adapter (HBA) interface card 735A operative to connect with a fibre channel network 790, a host bus adapter (HBA) interface card 735B operative to connect to a SCSI bus 739, and an optical disk drive 740 operative to receive an optical disk 742. Also included are a mouse 746 (or other point-and-click device, coupled to bus 712 via serial port 728), a modem 747 (coupled to bus 712 via serial port 730), and a network interface 748 (coupled directly to bus 712).

Bus 712 allows data communication between central processor 714 and system memory 717, which may include read-only memory (ROM) or flash memory (neither shown), and random access memory (RAM) (not shown), as previously noted. The RAM is generally the main memory into which the operating system and application programs are loaded and typically affords at least 64 megabytes of memory space. The ROM or flash memory may contain, among other code, the Basic Input-Output system (BIOS) which controls basic hardware operation such as the interaction with peripheral components. Applications resident with data processing system 710 are generally stored on and accessed via a computer readable medium, such as a hard disk drive (e.g., fixed disk 744), an optical drive (e.g., optical drive 740), floppy disk unit 737 or other storage medium. Additionally, applications may be in the form of electronic signals modulated in accordance with the application and data communication technology when accessed via network modem 747 or interface 748.

Storage interface 734, as with the other storage interfaces of data processing system 710, may connect to a standard computer readable medium for storage and/or retrieval of information, such as a fixed disk drive 744. Fixed disk drive 744 may be a part of data processing system 710 or may be separate and accessed through other interface systems. Modem 747 may provide a direct connection to a remote server via a telephone link or to the Internet via an internet service provider (ISP). Network interface 748 may provide a direct connection to a remote server via a direct network link to the Internet via a POP (point of presence). Network interface 748 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 7 to be present to practice the present invention. The devices and subsystems may be interconnected in different ways from that shown in FIG. 7. The operation of a computer system such as that shown in FIG. 7 is readily known in the art and is not discussed in detail in this application. Code to implement the present invention may be stored in computer-readable storage media such as one or more of system memory 717, fixed disk 744, optical disk 742, or floppy disk 738. Additionally, data processing system 710 may be any kind of computing device, and so includes personal data assistants (PDAs), network appliances, X-window terminals or other such computing devices. The operating system provided on data processing system 710 may be MS-DOS®, MS-WINDOWS®, OS/2®, UNIX®, Linux®, or another known operating system. Data processing system 710 also supports a number of Internet access tools, including, for example, an HTTP-compliant web browser having a JavaScript interpreter, such as Netscape Navigator®, Microsoft Explorer®, and the like.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof.

The present invention has been described in the context of fully functional data processing system or computer systems; however, those skilled in the art will appreciate that the present invention is capable of being distributed as a program product in a variety of forms, and that the present invention applies equally regardless of the particular type of signal bearing media used to actually carry out the distribution. Exemplary data processing systems may include one or more hosts, network switches, appliance and/or storage arrays and may implement in-band and/or out-of-band storage or data volume virtualization. Examples of such signal bearing media include recordable media such as floppy disks and CD-ROM, transmission type media such as digital and analog communications links, as well as media storage and distribution systems developed in the future. Additionally, it should be understood that embodiments of the present invention are not limited to a particular type of data processing or computer system. Rather, embodiments of the present invention may be implemented in a wide variety of data processing systems (e.g., host computer systems, network switches, network appliances, and/or disk arrays).

The above-discussed embodiments may be implemented using software modules which perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Consequently, the invention is intended to be limited only by the scope of the appended claims, giving full cognizance to equivalents in all respects.

1. A method of performing cascaded replication comprising:
replicating data to be written to a data volume of a first node to a data volume of a second node; and
replicating data to be written to said data volume of said second node to a data volume of a third node, wherein,
at least one of said replicating data to be written to said data volume of said first node to said data volume of said second node and said replicating data to be written to said data volume of said second node to said data volume of said third node comprises asynchronously replicating data.

2. The method of claim 1, wherein said replicating data to be written to said data volume of said first node comprises asynchronously replicating said data to be written to said data volume of said first node to said data volume of said second node.

3. The method of claim 2, wherein said replicating data to be written to said data volume of said second node comprises asynchronously replicating said data to be written to said data volume of said second node to said data volume of said third node.

4. The method of claim 2, wherein said replicating data to be written to said data volume of said second node comprises periodically replicating said data to be written to said data volume of said second node to said data volume of said third node.

5. The method of claim 2, wherein,
said replicating data to be written to said data volume of said first node comprises,
replicating data to be written to a data volume of a primary node to a data volume of an intermediate node; and
said replicating data to be written to said data volume of said second node comprises,
replicating data to be written to said data volume of said intermediate node to a data volume of a secondary node.

6. The method of claim 5, wherein said replicating data to be written to said data volume of said intermediate node comprises replicating data to be written to said data volume of said intermediate node to a data volume of each of a plurality of secondary nodes.

7. The method of claim 2, wherein,
said replicating data to be written to said data volume of said first node comprises replicating data to be written to said data volume of said first node to said data volume of said second node using a first data link coupled between said first node and said second node;
said replicating data to be written to said data volume of said second node comprises replicating data to be written to said data volume of said second node to said data volume of said third node using a second data link coupled between said second node and said third node; and
said first data link has a higher bandwidth than said second data link.

8. An apparatus configured to perform cascaded replication comprising:
means for replicating data to be written to a data volume of a first node to a data volume of a second node; and
means for replicating data to be written to said data volume of said second node to a data volume of a third node, wherein,
at least one of said means for replicating data to be written to said data volume of said first node to said data volume of said second node and said means for replicating data to be written to said data volume of said second node to said data volume of said third node comprises means for asynchronously replicating data.

9. The apparatus of claim 8, wherein said means for replicating data to be written to a data volume of a first node comprises means for asynchronously replicating said data to be written to said data volume of said first node to said data volume of said second node.

10. The apparatus of claim 9, wherein said means for replicating data to be written to said data volume of said second node comprises means for asynchronously replicating said data to be written to said data volume of said second node to said data volume of said third node.

11. The apparatus of claim 9, wherein said means for replicating data to be written to said data volume of said second node comprises means for periodically replicating said data to be written to said data volume of said second node to said data volume of said third node.

12. The apparatus of claim 9, wherein,
said means for replicating data to be written to said data volume of said first node comprises,
means for replicating data to be written to a data volume of a primary node to a data volume of an intermediate node; and
said means for replicating data to be written to said data volume of said second node comprises,
means for replicating data to be written to said data volume of said intermediate node to a data volume of a secondary node.

13. The apparatus of claim 12, wherein said means for replicating data to be written to said data volume of said intermediate node comprises means for replicating data to be written to said data volume of said intermediate node to a data volume of each of a plurality of secondary nodes.

14. The apparatus of claim 9, wherein,
said means for replicating data to be written to said data volume of said first node comprises means for replicating data to be written to said data volume of said first node to said data volume of said second node using a first data link coupled between said first node and said second node;
said means for replicating data to be written to said data volume of said second node comprises means for replicating data to be written to said data volume of said second node to said data volume of said third node using a second data link coupled between said second node and said third node; and
said first data link has a higher bandwidth than said second data link.

15. A machine-readable medium having a plurality of instructions executable by a machine embodied therein, wherein said plurality of instructions when executed cause said machine to perform a method comprising:
replicating data to be written to a data volume of a first node to a data volume of a second node; and
replicating data to be written to said data volume of said second node to a data volume of a third node, wherein,
at least one of said replicating data to be written to said data volume of said first node to said data volume of said second node and said replicating data to be written to said data volume of said second node to said data volume of said third node comprises asynchronously replicating data.

16. The machine-readable medium of claim 15, wherein said replicating data to be written to a data volume of a first node comprises asynchronously replicating said data to be written to said data volume of said first node to said data volume of said second node.

17. The machine-readable medium of claim 16, wherein said replicating data to be written to said data volume of said second node comprises asynchronously replicating said data to be written to said data volume of said second node to said data volume of said third node.

18. The machine-readable medium of claim 16, wherein said replicating data to be written to said data volume of said second node comprises periodically replicating said data to be written to said data volume of said second node to said data volume of said third node.

19. The machine-readable medium of claim 16, wherein,
said replicating data to be written to said data volume of said first node comprises,
replicating data to be written to a data volume of a primary node to a data volume of an intermediate node; and
said replicating data to be written to said data volume of said second node comprises,
replicating data to be written to said data volume of said intermediate node to a data volume of a secondary node.

20. The machine-readable medium of claim 19, wherein said replicating data to be written to said data volume of said intermediate node comprises replicating data to be written to said data volume of said intermediate node to a data volume of each of a plurality of secondary nodes.

21. The machine-readable medium of claim 16, wherein,
said replicating data to be written to said data volume of said first node comprises replicating data to be written to said data volume of said first node to said data volume of said second node using a first data link coupled between said first node and said second node;
said replicating data to be written to said data volume of said second node comprises replicating data to be written to said data volume of said second node to said data volume of said third node using a second data link coupled between said second node and said third node; and
said first data link has a higher bandwidth than said second data link.

22. A data processing system comprising:
a log to store data to be written to at least one of a data volume of a first node and a data volume of a second node; and
a replication facility configured to replicate data to be written to said data volume of said first node to said data volume of said second node and to replicate data to be written to said data volume of said second node to a data volume of a third node using said log, wherein,
said replication facility comprises a replication facility configured to asynchronously replicate at least one of said data to be written to said data volume of said first node and said data to be written to said data volume of said second node.

23. The data processing system of claim 22, wherein said replication facility further comprises,
a replication facility configured to asynchronously replicate said data to be written to said data volume of said first node to said data volume of said second node.

24. The data processing system of claim 23, wherein said replication facility further comprises,
a replication facility configured to asynchronously replicate said data to be written to said data volume of said second node to said data volume of said third node

25. The data processing system of claim 23, wherein said replication facility further comprises,
a replication facility configured to periodically replicate said data to be written to said data volume of said second node to said data volume of said third node
